(19) United States
(12) Patent Application Publication
(10) Pub. No.: US 2015/0363902 A1
(43) Pub. Date: Dec. 17, 2015

(54) AUTOMATIC SUCCESS/FAILURE DETERMINATION NOTIFICATION SYSTEM AND METHOD FOR SAFETY SURVEY RESULTS

(71) Applicant: NIPPON GAS CO., LTD., Chuo-ku, Tokyo (JP)

(72) Inventors: Shinji Wada, Tokyo (JP); Shingo Dekamo, Tokyo (JP)

(73) Assignee: NIPPON GAS CO., LTD., Chuo-ku, Tokyo (JP)

(21) Appl. No.: 14/764,134

(22) PCT Filed: Jan. 30, 2014
(86) PCT No.: PCT/JP2014/000498

§ 371 Date: Jul. 28, 2015

(30) Foreign Application Priority Data
Jan. 31, 2013 (JP) 2013-017791

(51) Int. Cl. G06Q 50/26; G06Q 10/00

(52) U.S. Cl. CPC G06Q 50/265; G06Q 10/00

(57) ABSTRACT

A safety management server receives code data from a mobile terminal, and on the basis of the code data, extracts safety inspection data including a safety inspection item, and determination data for making a pass/fail determination on the safety inspection item, and transmits the safety inspection data and the determination data to the mobile terminal. Subsequently, the mobile terminal receives the safety inspection data and the determination data, and on the basis of the determination data, makes a pass/fail determination of an inspection result input as data into the safety inspection item among the safety inspection data.

### TECHNICAL FIELD

The present invention relates to an automatic pass/fail determination of a safety inspection result, and a work notification system and method based on the safety inspection result.

### BACKGROUND ART

Conventionally, LP gas is divided into importation from gas-producing countries, and domestic production obtained as a by-product of the production process for petroleum products. Import terminals that store LP gas carried by tankers from gas-producing countries, as well as petroleum refining terminals, are respectively called primary terminals. LP gas is loaded onto coastal vessels and tank trucks, and shipped from primary terminals to secondary terminals, which are transit stations located along the coast or inland for LP gas shipping. Next, LP gas carried to secondary terminals is shipped to local LP gas filling stations (delivery bases), and transferred into pressurized gas cylinders at the delivery bases. The filled gas cylinders at each delivery base are delivered by deliverymen to customers such as general households, housing complexes, and offices. This is a supply method based on gas cylinders. Another supply method is based on gas bulk. This is a method in which a gas bulk installed at a customer location is filled with gas directly by a tank truck. Note that in this specification, gas cylinders and gas bulk may be collectively referred to as “gas containers” in some cases.

There is a possibility that LP gas supplied using these methods may lead to accidents such as gas leakage and explosions. For this reason, Japan has established laws with the primary objectives of ensuring safety in the event of an accident, preventing accidents, and upholding fair LP gas transactions, and gas suppliers are required to conduct periodic inspections of LP gas supply facilities and consumption facilities. Note that supply facilities mean from the gas container to the outlet of the gas meter, and periodic inspection under the supervision of the gas supplier is required. Also, consumption facilities mean from the outlet of the gas meter to each piece of gas equipment (such as a gas stove and a water heater, for example). For consumption facilities, the customer assumes responsibility, but similarly to the supply facilities, periodic inspection by the gas supplier is required.

There are two types of laws that require periodic inspections, the “Act Concerning the Securing of Safety and the Optimization of Transaction of Liquefied Petroleum Gas” (hereinafter designated the “LP law”) and the “Gas Business Act” (hereinafter designated the “GB law”), which are differentiated according to the supply format. The LP law regulates LP gas supply formats regarding a format of direct supply, such as transporting cylinders to customer locations (hereinafter, “general supply”), and a format of installing a simple gas-producing device, also called a gas facility, and supplying gas produced by the vaporization of LP gas to multiple customers via a pipeline. However, the LP law is applied when the scale of the supply destination, or in other words the customer, is less than 70 households. At 70 households and above, the Gas Business Act is applied. In this way, even though the facilities do not change, the laws to apply are different depending on the supply scale, and to distinguish the individual supply formats, the case of the LP law is designated “concentrated gas (supply)”, while the case of the GB law is designated “simple gas (supply)”. In addition, for both concentrated gas and simple gas, a gas facility which is a supply facility is designated the “parent”, while a consumption facility on the customer side is designated the “child” in some cases. Note that the supply destination of a gas facility is not multiple “consumption facilities”, but rather multiple “customers” (a customer obviously may own multiple consumption facilities, and ultimately gas may be supplied to multiple consumption facilities).

The LP law requires a periodic inspection of the supply facility and the consumption facility of a gas container once every four years. Note that this periodic inspection includes a piping inspection to inspect the gas pipes, and in the case of easily-corroded white gas pipes (older plated gas pipes), a yearly piping inspection is required as a general rule. Furthermore, in the case of a gas bulk, an inspection on a shorter interval such as every six months or every year is required in some cases. In addition, for consumption facilities, if re-inspection becomes necessary as a result of a periodic inspection, a re-inspection within one to six months after the inspection date is required. Re-inspection is limited to consumption facilities because consumption facilities are ultimately the property of the customer, and since the gas supplier is only able to recommend corrective action, re-inspection is conducted after a fixed period of time in order to check again. Hypothetically, if corrective action has not been taken at the time of a re-inspection, and continued supply is judged to be dangerous, the supply of gas may be stopped, and what are called cutoff measures may be taken in some cases. On the other hand, since supply facilities are the property of the gas supplier and inspection is carried out immediately when re-inspection becomes necessary, a specific time period is not stipulated in the LP law.

The GB law requires a periodic inspection of the supply facility once every 40 months. For periodic checks of a gas facility which is a supply facility, the time period differs according to the facility level. More specifically, in the case of a facility that adopts a method of forcibly vaporizing LP gas using electricity or gas, a check is carried out every day. If an automatic monitoring device is attached, a check is carried out once a month, otherwise a check is carried out once a week. In addition, similarly to the LP law, for consumption facilities, a re-inspection within one to six months after the inspection date is required. Furthermore, for supply facilities, a pipeline leakage survey is required once every 40 months. Of the gas pipes used for simple gas supply, the pipeline refers to the underground pipes laid parallel to roads (as opposed to the gas pipes leading from the pipeline to each customer, which are called “supply pipes”).

Additionally, besides the above inspections, periodic replacement of parts such as the gas alarm, gas meter, regulator, and gas hose is also conducted, along with management and work. In particular, there are many types of parts with individually different expiration dates, and parts must be replaced before the expiration date.

Note that this specification differentiates between the terms “inspection”, “check”, and “survey”. An “inspection” refers to an investigation that includes the consumption facilities inside a customer household. A “check” refers to an investigation of only the supply facilities, while a “survey” is an extension of a “check” and refers to a more detailed investigation of the supply facilities. Also, “inspection”, “check”, and “survey” may be collectively termed “inspection” in some cases. Additionally, inspection work and part replacement work is collectively termed safety work.

In this way, there are a variety of different inspections and periodic part replacements for LP gas supply facilities and consumption facilities. A safety inspector conducts this safety work, and uses an inspection slip to report the result.

However, currently the inspection slip is paper-based, but the inspection slips are divided into the two types of the LP law and the GB law, and for the case of the LP law, additionally divided into gas cylinders and gas bulks, for a total of three types. The safety inspector carries these inspection slips, and selects which inspection slip to use according to the facilities. In addition, the inspection items on an inspection slip include items such as the piping inspection, pipeline leakage survey, and periodic part replacement discussed above, some of which may be unnecessary depending on the type of safety work, and the safety inspector judges whether each item is required or not. Furthermore, the decision of which inspection items are required items is also entrusted to the safety inspector. Given these circumstances, issues such as mistakes or missing information in the inspection details may occur. Also, revisiting a location and conducting another inspection is also conceivable.

Also, inspection slips that were hand-written by the safety inspector at the worksite are taken back to a business operating base and a PC terminal is used to input data into a safety management system, but the safety inspector does not necessarily input the data personally, and it is conceivable that accurate data may not be reflected in some cases. In the related art, specialized software is installed onto a handy terminal, and the safety inspector uses the specialized software to conduct safety checks, for example. In addition, according to one proposal, a device used by a safety inspector communicates with a system to acquire customer information, a facility check format stored on the device in advance is selected and data is input, and the input check data is transmitted to the system (see PTL 1).

In the related art, safety checks must be made by the safety inspector personally in order to make a pass/fail determination of a safety inspection. As a result, it is difficult to improve efficiency.

### CITATION LIST

### Patent Literature

PTL 1: Japanese Patent Laid-Open No. 2010-165317

### SUMMARY OF INVENTION

### Technical Problem

The present invention was devised in light of such circumstances, and provides a system and method able to conduct an automatic pass/fail determination as a result of a safety inspection, and improve the efficiency of safety check work.

### Solution to Problem

In order to achieve such an objective, the present invention is a system, comprising a mobile terminal and a server, for supporting safety inspection, wherein the server receives code data from the mobile terminal, and on the basis of the code data, extracts safety inspection data including a safety inspection item, and determination data for making a pass/fail determination on the safety inspection item, and transmits the safety inspection data and the determination data to the mobile terminal, and the mobile terminal receives the safety inspection data and the determination data, and on the basis of the determination data, makes a pass/fail determination of an inspection result input as data into the safety inspection item among the safety inspection data.

### Advantageous Effects of Invention

According to the present invention, the time taken for safety work may be decreased, the efficiency of safety work may be increased, and mistakes in safety work may be reduced.

### BRIEF DESCRIPTION OF DRAWINGS

FIG. 1 is a diagram illustrating a network topology according to an embodiment of the present invention.

FIG. 2 is a block diagram illustrating a configuration of a mobile terminal according to an embodiment of the present invention.

FIG. 3 is a block diagram illustrating a configuration of a safety management server according to an embodiment of the present invention.

FIG. 4 is a diagram illustrating two-dimensional code data attached to consumption facilities and supply facilities according to an embodiment of the present invention.

FIG. 5 is a diagram illustrating customer data according to an embodiment of the present invention.

FIG. 6 is a diagram illustrating supply facility data according to an embodiment of the present invention.

FIG. 7 is a diagram illustrating inspection pattern data according to an embodiment of the present invention.

FIG. 8 is a flowchart illustrating an inspection slip data creation process according to an embodiment of the present invention.

FIG. 9 is a flowchart illustrating automatic determination of an inspection result on the basis of inspection slip data and a safety work details transmission process according to an embodiment of the present invention.

FIG. 10 is a diagram illustrating an example of a mobile terminal display screen of inspection slip data and inspection result data according to an embodiment of the present invention.

FIG. 11 is a diagram illustrating an example of a mobile terminal display screen of inspection slip data and inspection result data according to an embodiment of the present invention.

FIG. 12 is a diagram illustrating an example of a mobile terminal display screen of inspection slip data and inspection result data according to an embodiment of the present invention.

FIG. 13 is a diagram illustrating an example of a mobile terminal display screen of inspection slip data and inspection result data according to an embodiment of the present invention.

FIG. 14 is a diagram illustrating an example of a mobile terminal display screen of inspection slip data and inspection result data according to an embodiment of the present invention.

FIG. 15 is a diagram illustrating an example of a mobile terminal display screen of inspection slip data and inspection result data according to an embodiment of the present invention.

FIG. 16 is a diagram illustrating an example of inspection pass/fail determination data according to an embodiment of the present invention.

FIG. 17 is a diagram illustrating an example of a mobile terminal display screen expressing the pass/fail of an inspection result according to an embodiment of the present invention.

FIG. 18 is a diagram illustrating an example of a mobile terminal display screen expressing the pass/fail of an inspection result according to an embodiment of the present invention.

### DESCRIPTION OF EMBODIMENTS

This specification describes a system that supports safety checks of facilities at a customer home where an LP gas container is used, but this is merely an illustrative example. The technical ideas of the present invention are applicable to systems that support safety checks of facilities such as electrical facilities, gas facilities, water facilities, and various alarms installed in a customer home. In addition, this specification discloses using a mobile phone to scan a two-dimensional code (for example, a QR code (registered trademark) or barcode) affixed to a gas meter, but another elements (such as an IC tag, for example) may also be used insofar as information enabling identification of a customer is obtained.

The embodiments described in this specification are merely illustrative examples. The present invention is not limited to such embodiments, and it should be appreciated that various modifications are possible. In addition, the methods, functions, and elements described in the embodiments may also be embodied as a computer-executable program, and in addition, may also be embodied as a computer-readable recording medium storing such a program.

Hereinafter, an overall configuration of a system according to the present embodiment will be described with reference to the drawings. The system herein is a system able to make an automatic pass/fail determination of a safety inspection result.

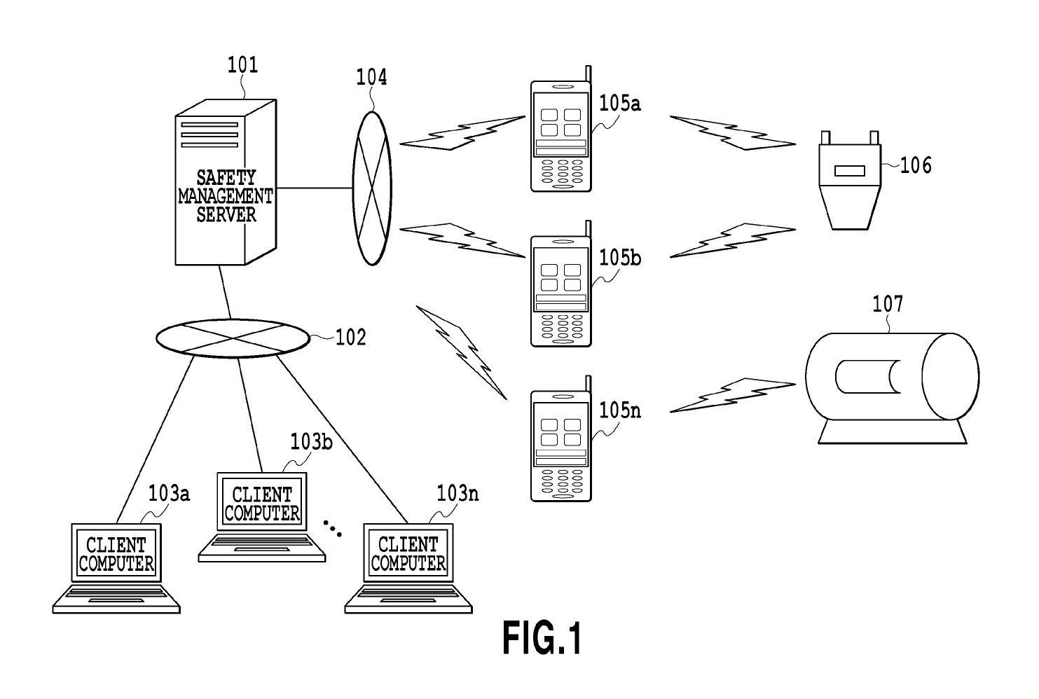

FIG. 1 is a diagram illustrating a network topology according to an embodiment of the present invention. In FIG. 1, a safety management server 101, which is installed in a data center or the like, for example, is configured to communicate via a network 102 with multiple client computers 103a, 103b, . . . , 103n (hereinafter designated the “client computer 103”) installed in each business operating base, for example, and also to communicate via a network 104 with multiple mobile terminals 105a, 105b, . . . , 105n (hereinafter designated the “mobile terminal 105”). The mobile terminal is carried by a safety inspector who conducts safety work, and is configured to be able to scan a two-dimensional code attached to a consumption facility 106 and a supply facility 107.

A safety inspection application is preinstalled in the mobile terminal 105. After a successful two-dimensional scan of a two-dimensional code, for example, the application transmits the scanned two-dimensional code data to the safety management server 101. The application is also able to download inspection slip data created on the safety management server 101 side (safety inspection data including safety inspection items). On a mobile terminal 105, downloaded inspection slip data is displayed on-screen, and if the safety inspector inputs inspection result data into a safety inspection item, the input data is transmitted to the safety management server 101.

Affixed to the consumption facility 106 and the supply facility 107 are respective two-dimensional codes with embedded facility data.

When the two-dimensional code affixed to the consumption facility 106 or the supply facility 107 is scanned by the mobile terminal 105, the mobile terminal 105 transmits the scanned two-dimensional code data to the safety management server 101, on the basis of the safety inspection application.

The safety management server 101 receives the two-dimensional code data, and on the basis of the two-dimensional code data, selects inspection item data, and creates and transmits inspection slip data to the mobile terminal 105. The mobile terminal 105 receives and displays the inspection slip data on an output device. Next, if an inspection result is input into each inspection item of the inspection slip via an input device of the mobile terminal 105, the safety inspection application checks the input data, and then transmits inspection result data to the safety management server 101.

The safety management server 101 receives and stores the inspection result data. After that, the inspection result data may be viewed from a client computer 103 or a mobile terminal 105.

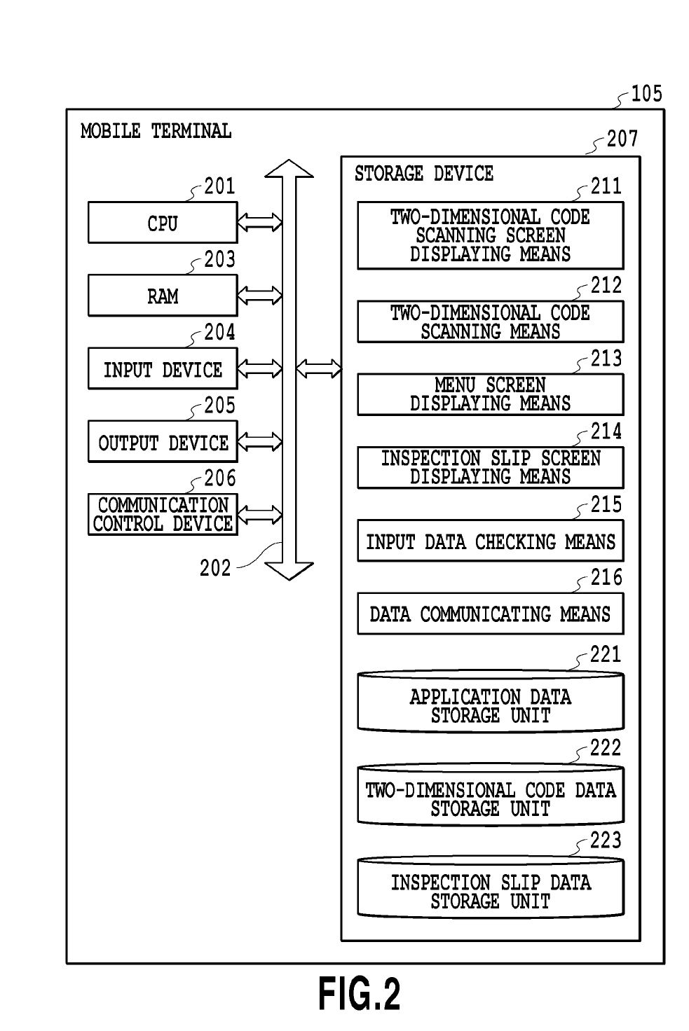

Next, a configuration of the mobile terminal 105 discussed above will be described in detail with reference to the block diagram in FIG. 2.

The mobile terminal 105 includes a configuration in which RAM 203, an input device 204, an output device 205, a communication control device 206, and a storage device 207 realized with a non-volatile storage medium (such as ROM or an HDD) are connected to a CPU 201 via a system bus 202. The storage device 207 is provided with a program storage area that stores software programs for exhibiting each function of the safety inspection application, and a data storage area that stores information such as inspection slip data. Each elements of the program storage area described hereinafter is actually an independent software program, or a routine or component thereof, which exhibits each function by being called from the storage device 207 by the CPU 201, loaded into a work area of the RAM 203, and sequentially executed.

To give only examples related to the present embodiment, the data storage area in the mobile terminal 105 is provided with an application data storage unit 221, a two-dimensional code data storage unit 222, and an inspection slip data storage unit 223. All are fixed storage areas reserved inside the storage medium 207.

The application data storage unit 221 stores data related to an application for safety inspection of the consumption facility 106 and the supply facility 107. In one embodiment, display screen data (for example, HTML data) for a two-dimensional code scanning screen and an inspection slip screen is stored. However, it should be understood that the two-dimensional code scanning is not strictly necessary in the case of using a typical two-dimensional code scanning application for a mobile terminal. In this case, the safety inspection application is activated when triggered by the scanning of a two-dimensional code, and two-dimensional code data is transmitted to the safety management server.

The two-dimensional code data storage unit 222 stores the two-dimensional code data discussed above. In one embodiment, a “parent/child classification” that identifies the consumption facility 106 or the supply facility 107 (the supply facility 107 is the parent, while the consumption facility 106 is the child), a “meter company number” which is a unique identifier of the consumption facility 106 and the supply facility 107, a “manufacturer code” which is a unique identifier of the manufacturer of the consumption facility 106 or the supply facility 107, a “model type” indicating the model type, and a “part number” indicating a product number are stored. The “parent/child classification” may be “0” to indicate the consumption facility 106 which is the child, and “1” to indicate the supply facility 107 which is the parent, for example. Also, the “meter company number” is a code of fixed length obtained by combining the “manufacturer code”, “model type”, and “part number”, for example.

The inspection slip data storage unit 223 stores inspection slip data downloaded from the safety management server 101, and inspection result data input by the safety inspector. In one embodiment, the “meter company number”, a “safety inspector code” that identifies the safety inspector conducting the inspection, each inspection item, and inspection result data for each inspection item are stored.

The software program stored in the program storage area in the mobile terminal 105 is equipped with two-dimensional code scanning screen displaying portion 211, two-dimensional code scanning portion 212, menu screen displaying portion 213, inspection slip screen displaying portion 214, input data checking portion 215, and data communicating portion 216.

The two-dimensional code scanning screen displaying portion 211 acquires two-dimensional code scanning screen data from the application data storage unit 221, and displays a two-dimensional code scanning screen on the output device 205 of the mobile terminal 105.

After the two-dimensional code scanning screen is displayed, and the scanning of a two-dimensional code is received, the safety inspector uses the two-dimensional code scanning portion 212 to read a two-dimensional code affixed to the main body of the consumption facility 106 or the supply facility 107. The two-dimensional code data that is read is converted into digital data and stored in the two-dimensional code data storage unit 222.

The menu screen displaying portion 213 acquires inspection slip screen data from the application data storage unit 221, and displays an inspection menu screen on the output device 205 of the mobile terminal 105 on the basis of the downloaded inspection slip data.

The inspection slip screen displaying portion 214 acquires inspection slip screen data from the application data storage unit 221, and displays an inspection slip screen on the output device 205 of the mobile terminal 105 on the basis of the downloaded inspection slip data.

The input data checking portion 215 conducts an input data check of inspection result data input into the inspection slip screen when the safety inspector conducts an inspection. When the input data check returns an error, the error is displayed on the output device 205 with a popup message or the like, and the safety inspector is prompted to correct the error. When the input data check returns a normal result, the inspection result data is stored in the inspection slip data storage unit 223.

The data communicating portion 216 transmits two-dimensional code data and inspection result data to the safety management server 101. In addition, the created inspection slip data is received at the safety management server 101, and stored in the inspection slip data storage unit 223.

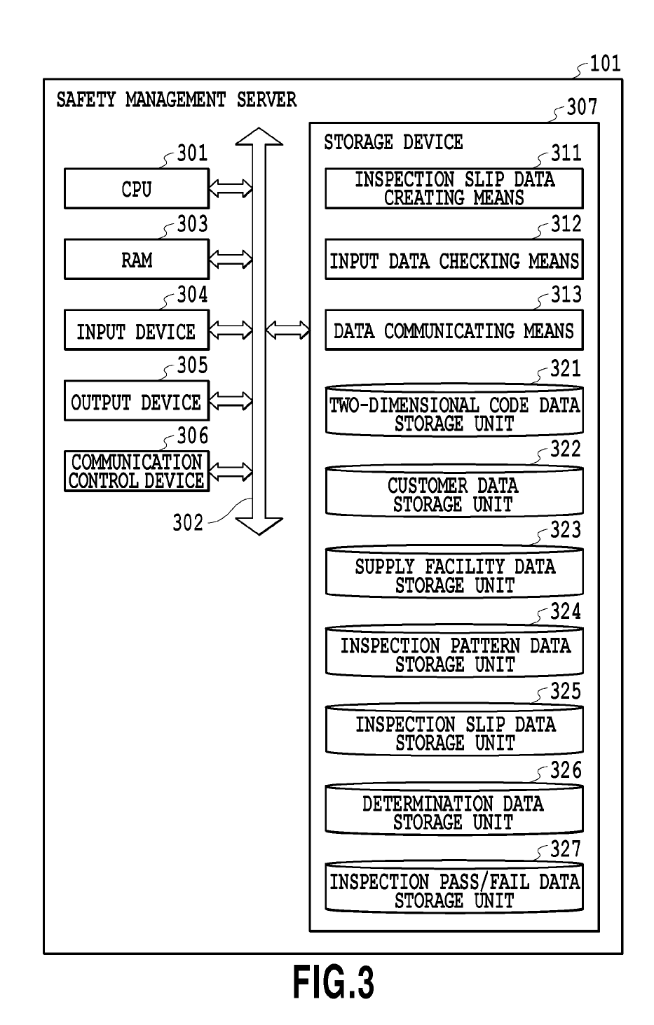

Next, a configuration of the safety management server 101 discussed above will be described in detail with reference to the block diagram in FIG. 3.

The safety management server 101 includes a configuration in which RAM 303, an input device 304, an output device 305, a communication control device 306, and a storage device 307 realized with a non-volatile storage medium (such as ROM or an HDD) are connected to a CPU 301 via a system bus 302. The storage device 307 is provided with a program storage area that stores software programs for exhibiting each function of the safety management server 101, and a data storage area that stores information such as customer data. Each elements of the program storage area described hereinafter is actually an independent software program, or a routine or component thereof, which exhibits each function by being called from the storage device 307 by the CPU 301, loaded into a work area of the RAM 303, and sequentially executed.

The data storage area in the safety management server 101 includes a two-dimensional code data storage unit 321, a customer data storage unit 322, a supply facility data storage unit 323, an inspection pattern data storage unit 324, an inspection slip data storage unit 325, a determination data storage unit 326, and an inspection pass/fail data storage unit 327.

The two-dimensional code data storage unit 321 stores two-dimensional code data received from the mobile terminal 105.

The customer data storage unit 322 stores information related to safety work in units of customers. In one embodiment, the customer data storage unit 322 stores a “customer code” for uniquely identifying a customer, a “customer classification” indicating whether the consumption facility 106 (customer facility) is related to the LP law or the GB law, a “meter company number”, and a “supply facility code” for uniquely identifying the supply facility 107 paired with the consumption facility 106. When the consumption facility 106 is related to the LP law, or in other words, in the case of a consumption facility 106 in the general supply format or the concentrated gas supply format, the “customer classification” stores “0”, whereas when the consumption facility 106 is related to the GB law, or in other words, in the case of a consumption facility 106 in the simple gas supply format, the “customer classification” stores “1”. Also, the “meter company number” stored in the customer data storage unit 322 is the “meter company number” of the consumption facility 106.

The supply facility data storage unit 323 stores information related to safety work in units of supply facilities. In one embodiment, the supply facility data storage unit 323 stores a “supply facility code” for uniquely identifying the supply facility 107, a “supply classification” indicating whether the supply facility 107 is a facility in the general supply format or a facility in the concentrated gas supply format, a “container classification” indicating whether a gas container related to the supply facility 107 is a cylinder or a bulk, and a “meter company number”. The “supply classification” stores “1” in the case of a facility in the concentrated gas supply format, and stores “0” otherwise. Additionally, “2” may also be stored in the case of also managing data about the simple gas supply format. Also, the “container classification” stores “0” when the gas container is a cylinder, and “1” when the gas container is a bulk.

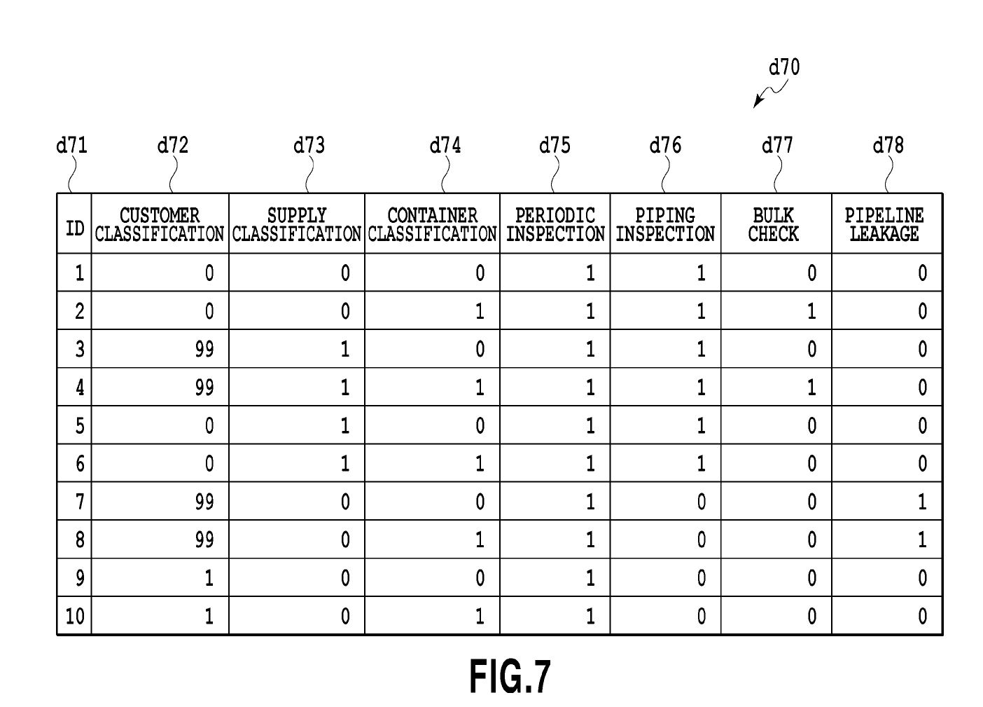

The inspection pattern data storage unit 324 stores pattern data of inspection items selected on the basis of facility data about the consumption facility 106 and the supply facility 107 (hereinafter designated inspection pattern data; see FIG. 7). In one embodiment, the inspection pattern data storage unit 324 stores an “ID” which is a unique serial number for uniquely identifying the inspection pattern data, a “customer classification”, a “supply classification”, and a “container classification”. The inspection pattern data includes inspection items that are available for selection due to the combination of the “customer classification”, the “supply classification”, and the “container classification”. The inspection items that are available for selection include “periodic inspection”, “piping inspection”, “bulk check”, and “pipeline leakage”, for example. For each inspection item, the inspection pattern data storage unit 324 stores “1” for example when an inspection item is selected due to the combination of the “customer classification”, the “supply classification”, and the “container classification”, and stores “0” for example when not selected.

The inspection slip data storage unit 325 stores created inspection slip data, and inspection result data received from the mobile terminal 105. In one embodiment, the “meter company number”, a “safety inspector code” that identifies the safety inspector conducting the inspection, each inspection item, and inspection result data for each inspection item are stored.

The determination data storage unit 326 is data created in advance on the basis of inspection slip data, and stores inspection pass/fail determination data that acts as a reference for determining whether or not each item of the inspection result data passes inspection. The inspection pass/fail determination data is determination data for determining whether inspection items pass or fails.

When an item of the inspection result data fails inspection, the inspection pass/fail data storage unit 327 stores failure safety work data that includes detailed data about the safety work to perform next.

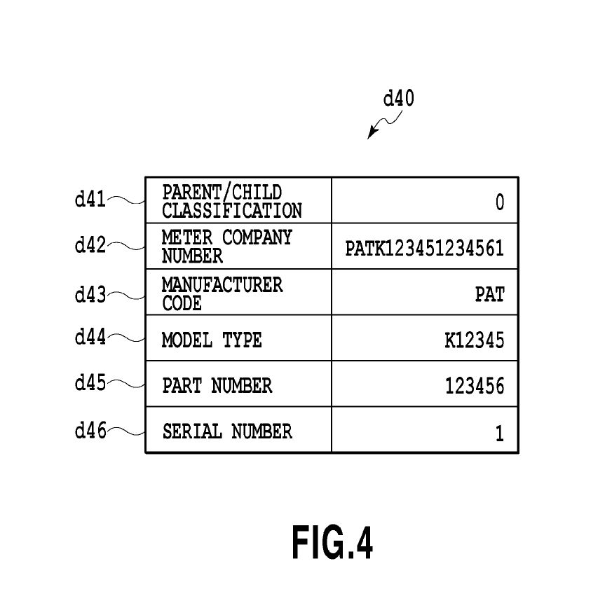

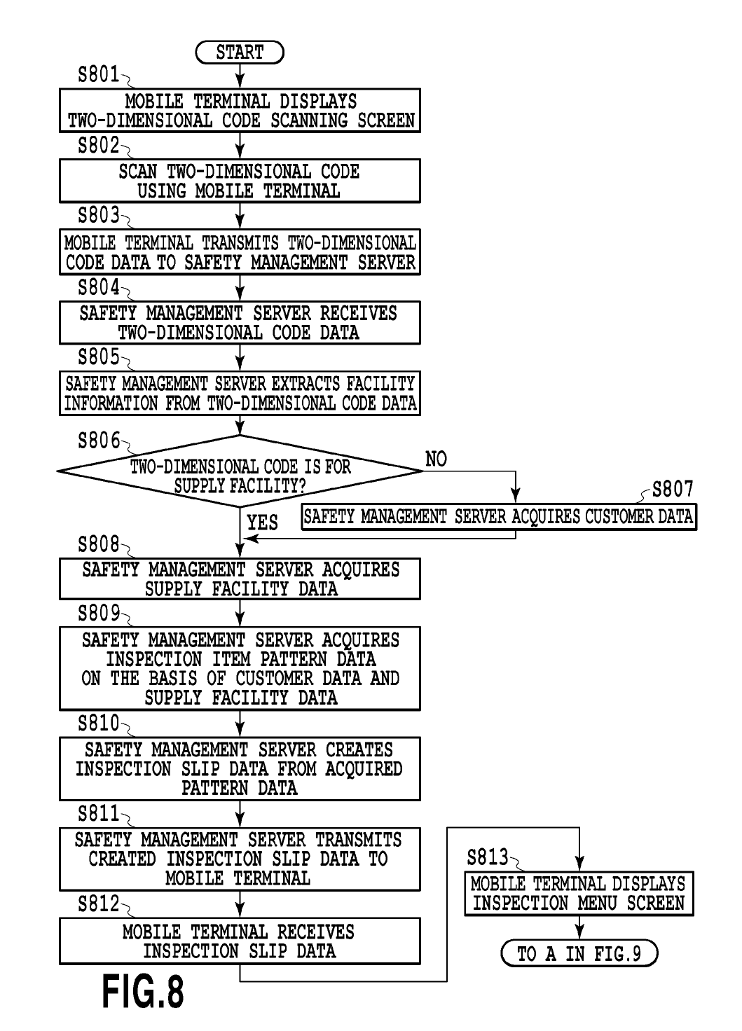

Next, operation of a safety inspection realized by the safety management server 101 will be described. First, an overview of operation will be described. The safety management server 101 receives two-dimensional code data from the mobile terminal 105, and on the basis of the two-dimensional code data, extracts inspection slip data that includes inspection items and determination data for determining whether the inspection items pass or fail, and transmits the inspection slip data and the determination data to the mobile terminal 105. The mobile terminal 105 receives the inspection slip data and the determination data, and on the basis of the determination data, determines the pass/fail state of the inspection result input as data for the inspection items in the inspection slip data, displays the inspection result, and transmits the inspection result to the safety management server 101. An inspection slip data creation process according to an embodiment will be described in detail with reference to the tables in FIGS. 4 to 7 and the flowchart in FIG. 8.

FIG. 8 is a flowchart illustrating an inspection slip data creation process according to an embodiment of the present invention. First, in step 801, the safety inspection application is activated on the mobile terminal 105, and the two-dimensional code scanning screen is displayed on the screen of the mobile terminal 105. It should be understood that enabling the scanning of a two-dimensional code is sufficient, and the safety inspection application may be substituted by another application. Next, the safety inspector uses the mobile terminal 105 to scan a two-dimensional code affixed to the consumption facility 106 or the supply facility 107 (step 802).

Herein, FIG. 4 illustrates one embodiment of two-dimensional code data read in step 802. Each data item in FIG. 4 is delimited with a comma or other delimiter, and embedded into a two-dimensional code. Note that in the present working example, the content of the “parent/child classification” d41 of the two-dimensional code data d40 in FIG. 4 is “0” in the case of the consumption facility 106 which is the child, and “1” in the case of the supply facility 107 which is the parent. For this reason, FIG. 4 illustrates two-dimensional code data affixed to the consumption facility 106. Also, the “meter company number” d42 is a unique code obtained by combining the “manufacturer code” d43, the “model type” d44, the “part number” d45, and the “serial number” d46.

Returning to FIG. 8, after the safety inspection application successfully scans the two-dimensional code data in step 802, the scanned two-dimensional code data is transmitted to the safety management server 101 (step 803). Next, the safety management server 101 receives the two-dimensional code (step 804), and from the received two-dimensional code, extracts the “parent/child classification” and the “meter company number” which is one instance of facility information (step 805). Furthermore, on the basis of the extracted “parent/child classification”, the safety management server 101 determines whether the scanned two-dimensional code is the two-dimensional code of the consumption facility 106 or the two-dimensional code of the supply facility 107 (step 806). This determination is judged from the value of the supply facility code in the two-dimensional code.

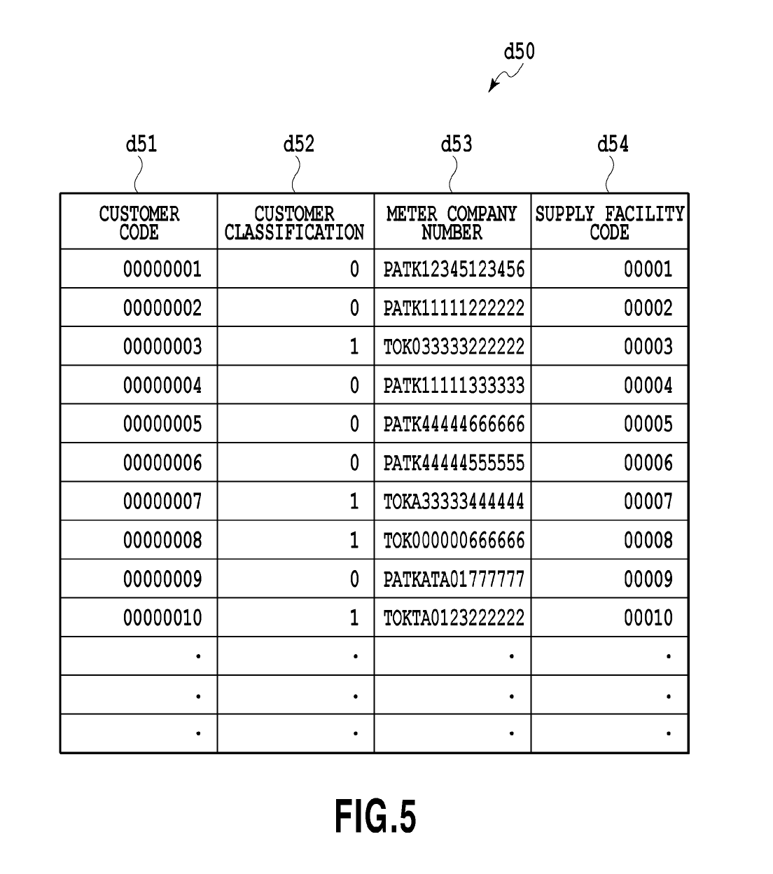

In step 806, if the two-dimensional code is the two-dimensional code of the consumption facility 106, the process proceeds to No, and the safety management server 101 acquires customer data by using the meter company number extracted from the two-dimensional code as a search key (step 807). Herein, FIG. 5 illustrates one embodiment of customer data. The customer data d50 in FIG. 5 includes a “customer code” d51, a “customer classification” d52, a “meter company number” d53, and a “supply facility code” d54. When the consumption facility 106 is related to the LP law, or in other words, in the case of a consumption facility 106 in the general supply format or the concentrated gas supply format, the “customer classification” d52 of the customer data d50 in FIG. 5 stores “0”, whereas when the consumption facility 106 is related to the GB law, or in other words, in the case of a consumption facility 106 in the simple gas supply format, the “customer classification” d52 stores “1”. Also, the “meter company number” d53 is the “meter company number” of the consumption facility 106. Furthermore, the “supply facility code” d54 is a code that uniquely indicates the supply facility 107 paired with the consumption facility 106. A primary reason for including the “supply facility code” in the customer data is because in the case of this route of acquiring data from the customer data, the “meter company number” included in the read-in two-dimensional code is the “meter company number” of the consumption facility 106, and the supply facility code is used as a search key when searching for the supply facility data in the following step 808.

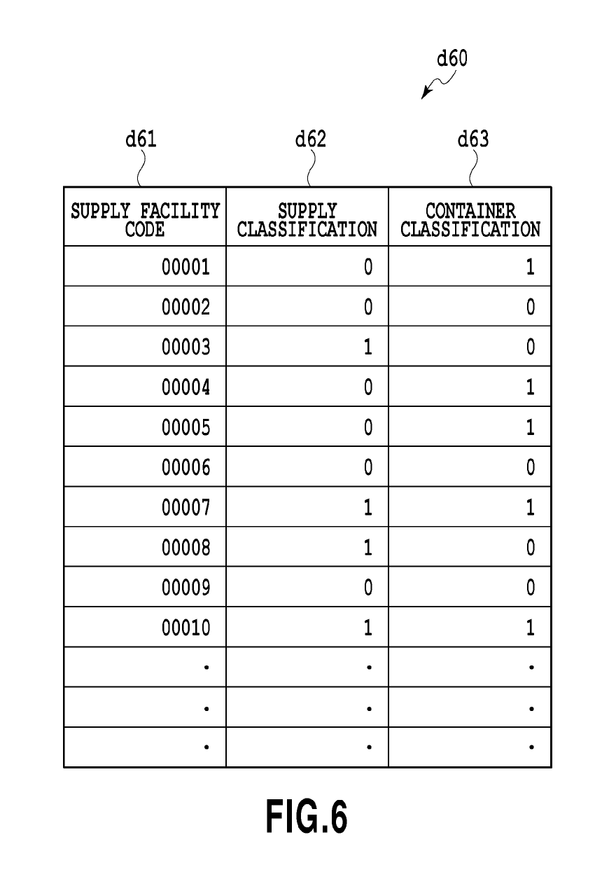

After acquiring customer data, the safety management server 101 additionally acquires supply facility data using the supply facility code acquired from the customer data as a search key (step 808). Herein, FIG. 6 illustrates one embodiment of supply facility data. The supply facility data d60 in FIG. 6 includes a “supply facility code” d61, a “supply classification” d62, and a “container classification” d63. The “supply classification” d62 of the supply facility data d60 in FIG. 6 stores “1” in the case of a facility in the concentrated gas supply format, and stores “0” otherwise. Also, the “container classification” d63 stores “0” when the gas container is a cylinder, and “1” when the gas container is a bulk. After that, the process proceeds to step 809.

In step 806, if the two-dimensional code is the two-dimensional code of the supply facility 107, the process proceeds to Yes, and the safety management server 101 acquires supply facility data by using the meter company number extracted from the two-dimensional code as a search key (step 808). Although described as the same step 808 as the No route in step 806 (the case of the consumption facility 106), it should be noted that the search key is different. After that, the process proceeds to step 809.

Next, the safety management server 101 searches inspection pattern data on the basis of the acquired customer data and the supply facility data, or more specifically, by using the “customer classification” acquired from the customer data as well as the “supply classification” and “container classification” acquired from the supply facility data as the search key, and acquires a relevant record (step 809). Herein, FIG. 7 illustrates one embodiment of inspection pattern data. The inspection pattern data d70 illustrated in FIG. 7 includes an “ID” d71, a “customer classification” d72, a “supply classification” d73, a “container classification” d74, a “periodic inspection” d75, a “piping inspection” d76, a “bulk check” d77, and a “pipeline leakage” d78. The inspection pattern data d70 is a combination of the “customer classification” d72, the “supply classification” d73, and the “container classification” d74, while selection availability data for each inspection is stored in “periodic inspection” d75 and thereafter. The content of the inspection pattern data will be described. Herein, a description will be given for the case in which the gas container is a cylinder, the supply format is concentrated gas and the LP law is applied, the “customer classification” d72 is “0”, the “supply classification” d73 is “1”, and the “container classification” d74 is “0”, or in other words, the case in which the “ID” d71 is “5”. In this case, the inspections which are “1” in the selection availability data for each inspection in “periodic inspection” d75 and thereafter are the “periodic inspection” d75, the “piping inspection” d76, and “part replacement”. Note that this “1” indicates that an inspection item is available for selection with the combination of the “customer classification” d72, the “supply classification” d73, and the “container classification” d74. For this reason, in this case, the three inspections are considered as selections which may be selected, and are displayed on the inspection menu screen discussed later.

Note that in the inspection pattern data d70 of FIG. 7, the data “99” is included in the “customer classification” d72. This means the case of the “customer classification” d72 was not acquired, or in other words the case of being the supply facility 107 (the case of the Yes route in step 806).

Next, the safety management server 101 selects inspection items on the basis of the acquired inspection pattern data, and creates inspection slip data made up of data of the selected inspection items (step 810). At this point, if there are multiple inspections which may be selected (for example, “periodic inspection”, “piping inspection”, and “part replacement”), it is necessary to narrow down the inspection to conduct, and thus the inspection slip data includes inspection menu screen data for making a selection.

Next, the safety management server 101 transmits the created inspection slip data and the inspection pass/fail determination data to the mobile terminal 105 (step 811). The inspection pass/fail determination data refers to data for making a pass/fail determination on the basis of an inspection result, and is data stored in advance in the determination data storage unit 326 of the safety management server 101. The inspection pass/fail determination data is, for example, gas pressure threshold data for determining whether or not a gas leak is occurring during a leakage inspection. The mobile terminal 105 stores the inspection slip data and the inspection pass/fail determination data in the storage device 202.

The mobile terminal 105 receives the inspection slip data from the safety management server 101 (step 812), and displays an inspection menu screen (step 813). From the inspection menu screen, if the safety inspector selects a link, button, or the like for an inspection to conduct, the screen transitions to an individual inspection slip screen. The inspection slip screen includes each inspection item, as well as a user interface enabling the safety inspector to input an inspection result, such as an input field, selection options, and the like for an inspection result. Note that when there is one inspection which may be selected in the inspection pattern data acquired in step 809, the inspection slip screen related to that one inspection may also be displayed directly, without displaying the inspection menu screen.

Also, in another embodiment, if the safety management server 101 is able to reference, from a read-in two-dimensional code, safety work schedule data (not illustrated) for the consumption facility 106 or the supply facility 107 associated with the two-dimensional code, and specify an inspection to be performed from the schedule data by treating the date the two-dimensional code was read in (in other words, the date of conducting safety work, such as the system date of the server, for example) as the scheduled work date, an inspection menu screen or an inspection slip menu related to the specified inspection may also be displayed.

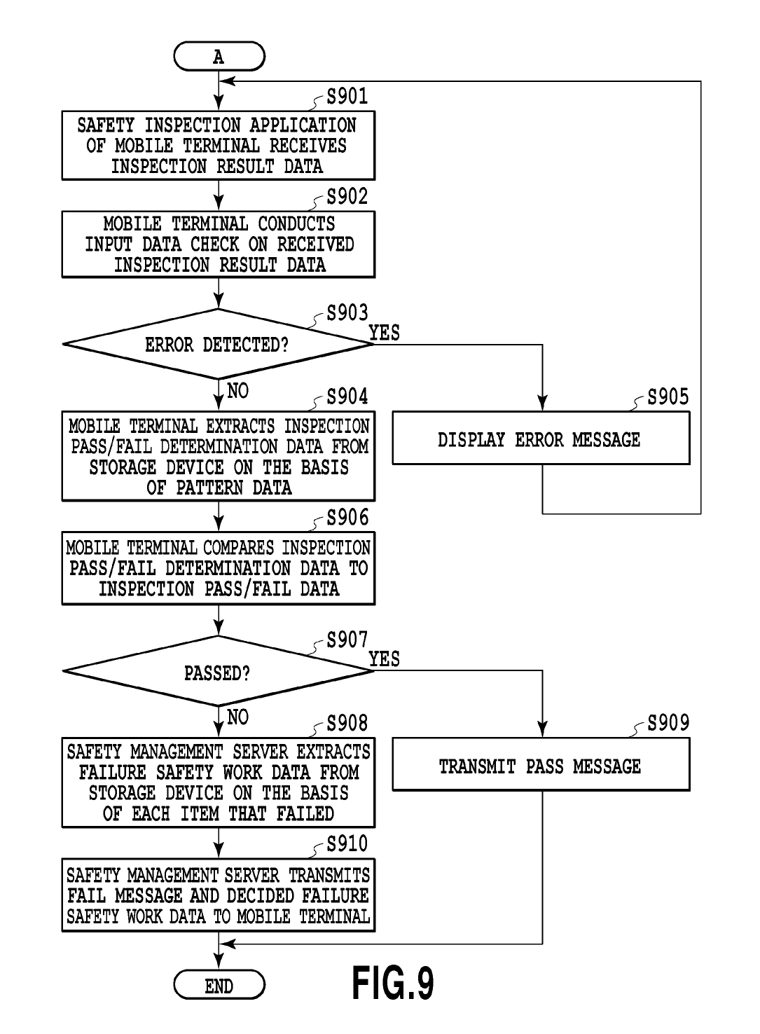

FIG. 9 is a flowchart illustrating an inspection slip data transmission process according to an embodiment of the present invention. First, in step 901, the safety inspection application receives inspection result data input by the safety inspector via an inspection slip screen displayed on the mobile terminal 105.

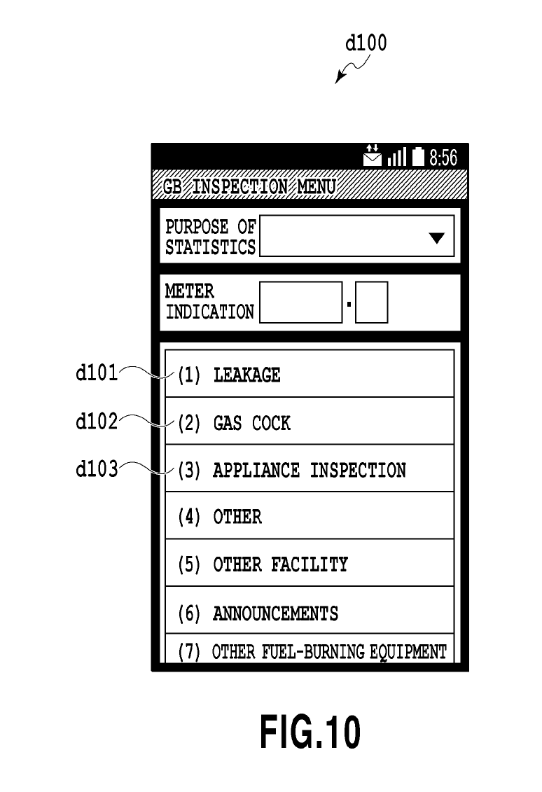

FIGS. 10 to 15 illustrate an example of mobile terminal display screens of inspection slip data and inspection result data according to an embodiment of the present invention. Unless specifically noted otherwise, the screens are for a safety inspection conducted on the basis of the GB law.

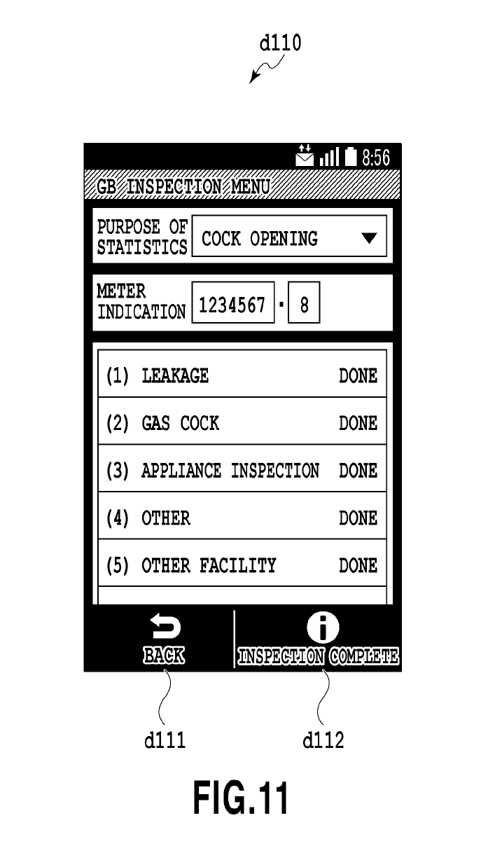

FIG. 10 and FIG. 11 illustrate an example of mobile terminal display screens of inspection slip data and inspection result data according to an embodiment of the present invention, and illustrate inspection slip data menu screens. FIG. 10 illustrates an example of a mobile terminal display screen of inspection slip data transmitted from the inspection slip data storage unit 325 of the safety management server 101. This screen d100 includes safety inspection items conducted on the basis of the GB law. The user of the mobile terminal is able to transition from this screen d100 to each safety inspection item. The safety inspection items refer to safety inspections such as “leakage” d101, “gas cock” d102, and “appliance inspection” d103. Also, the safety inspector is able to input a “meter indication” d104 on this screen. FIG. 11 illustrates an example d110 of a mobile terminal display screen expressing inspection result data after being input into the inspection slip data. By pressing a menu button, the user of the mobile terminal is able to select and press “Back” d111 and “Inspection complete” d112 buttons. If the “Inspection complete” d112 button is pressed, each piece of inspection result data is transmitted to the safety management server.

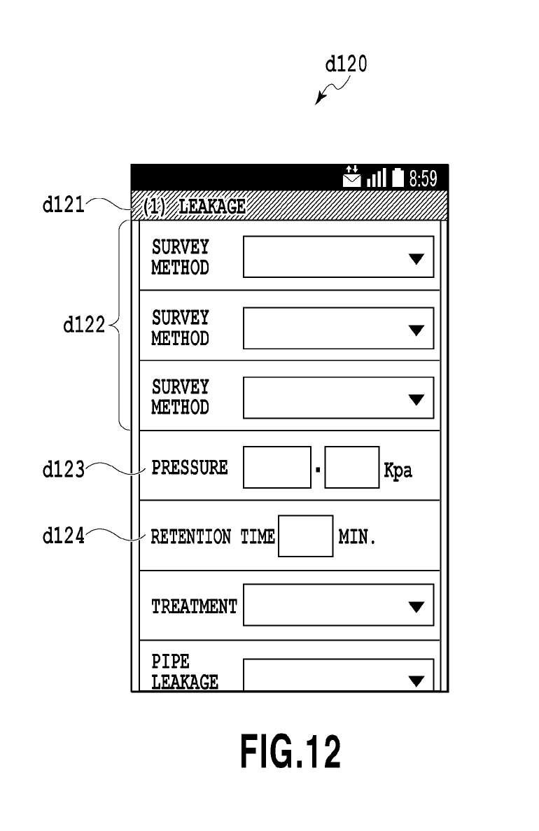

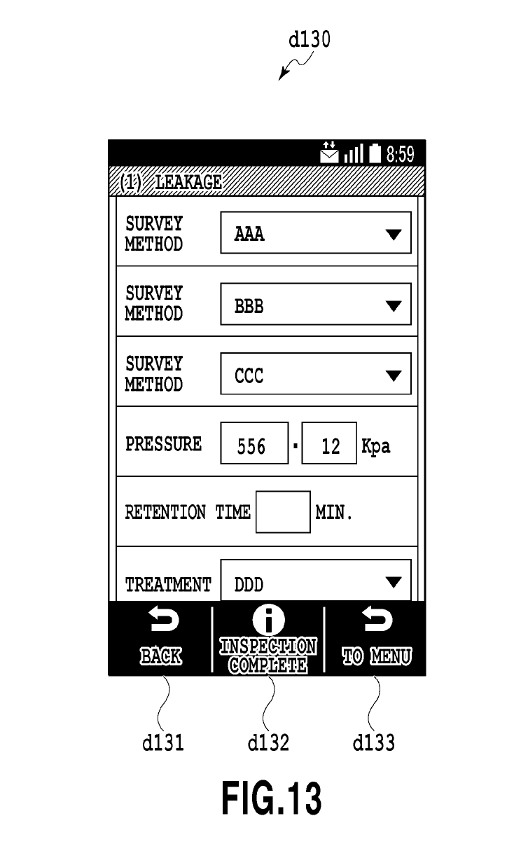

FIG. 12 and FIG. 13 illustrate an example of mobile terminal display screens of inspection slip data and inspection result data according to an embodiment of the present invention, and illustrate screens of inspection slip data during a leakage inspection. FIG. 12 illustrates an example d120 of a mobile terminal display screen of inspection slip data. The safety inspector uses a designated “survey method” d122 for safety inspection in “leakage” d121, and inspects factors such as the “pressure (kPa)” at the time of the survey and the “retention time (min)” during the survey. Subsequently, the safety inspector inputs the inspection result into the inspection slip data. FIG. 13 illustrates an example d130 of a mobile terminal display screen expressing inspection result data after being input into the inspection slip data. By pressing a menu button, the user of the mobile terminal is able to select and press “Back” d131, “Inspection complete” d132, and “To menu” d133 buttons. If the “Inspection complete” d132 button is pressed, the screen transitions to the menu screen of inspection slip data illustrated in FIG. 10 and FIG. 11.

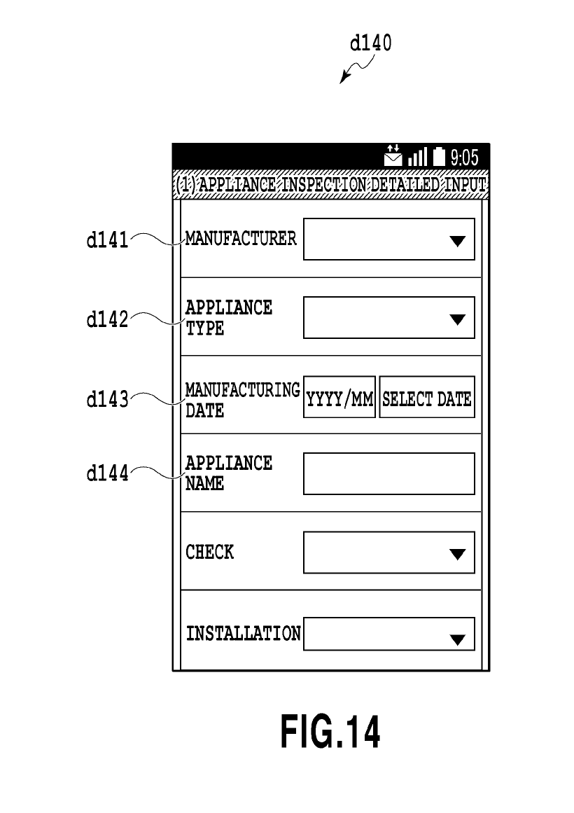

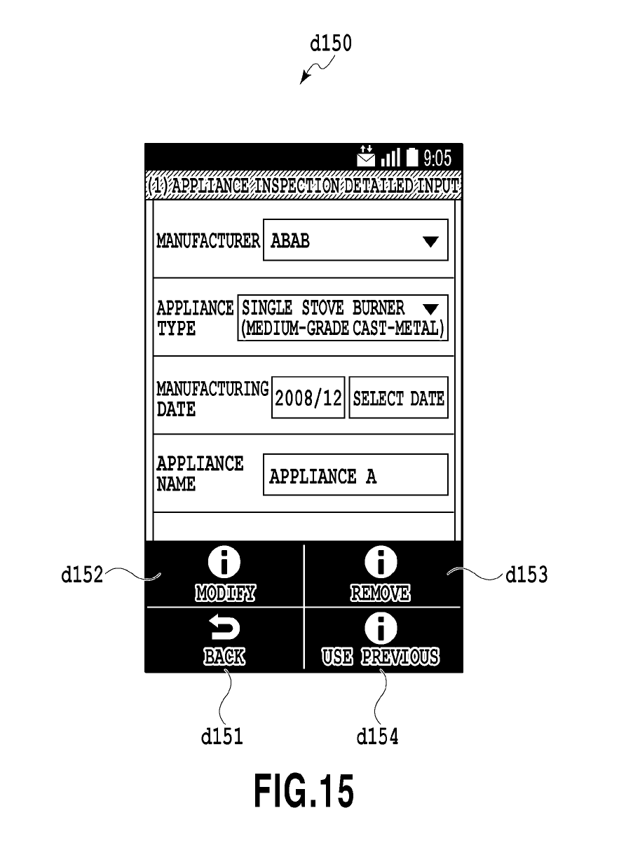

FIG. 14 and FIG. 15 illustrate an example of mobile terminal display screens of inspection slip data and inspection result data according to an embodiment of the present invention, and illustrate screens of inspection slip data during an appliance inspection. FIG. 14 illustrates an example d140 of a mobile terminal display screen of inspection slip data. As part of the safety inspection for an appliance inspection, the safety inspector checks and inputs information such as the “manufacturer” d141, the “appliance type” d142, the “manufacturing date” d143, and the “appliance name” d144 into the inspection slip data. Subsequently, the safety inspector inputs the inspection result into the inspection slip data. FIG. 15 illustrates an example d150 of a mobile terminal display screen expressing inspection result data after being input into the inspection slip data. By pressing a menu button, the user of the mobile terminal is able to select and press “Back” d151, “Modify” d152, “Remove” d153, “Use previous” d154 buttons. If the “Use previous” d154 button is pressed, the screen transitions to an appliance inspection screen (not illustrated), and if an “Inspection complete” button is pressed there, the screen transitions to the menu screen of inspection slip data illustrated in FIG. 10 and FIG. 11.

Following step 901 illustrated in FIG. 9, the safety inspection application of the mobile terminal conducts an input data check on the inspection result data (step 902). Herein, an input data check refers to checks such as a required input check, a data discrepancy (consistency) check, and a data validity check, for example. A required input check checks whether or not items marked as required among the inspection slip data have all been entered. A data discrepancy (consistency) check checks whether or not the name of the manufacturer of an appliance input into the inspection slip data matches the name of the manufacturer of an appliance registered in the safety management server, for example. The data validity check checks whether or not letters or other characters that are not numerals have been input into the numerical value input for the gas pressure, for example. In this way, the input data check conducts only formal checks. Substantial checks are conducted in step 908 discussed later.

When a formal error is detected by the input data check of step 903, the process proceeds to the Yes route, and the safety inspection application displays an indication on the screen of the mobile terminal 105 as an error message (step 905), and prompts the safety inspector for correction. In this case, the process returns to step 901 and repeats steps 901 to 903 and 905 until an error is no longer detected by the input data check.

When an error is not detected by the input data check of step 903, the process proceeds to the No route, and the mobile terminal 105 follows the safety inspection application to extract inspection pass/fail determination data from the storage device 207 on the basis of the pattern data (step 904).

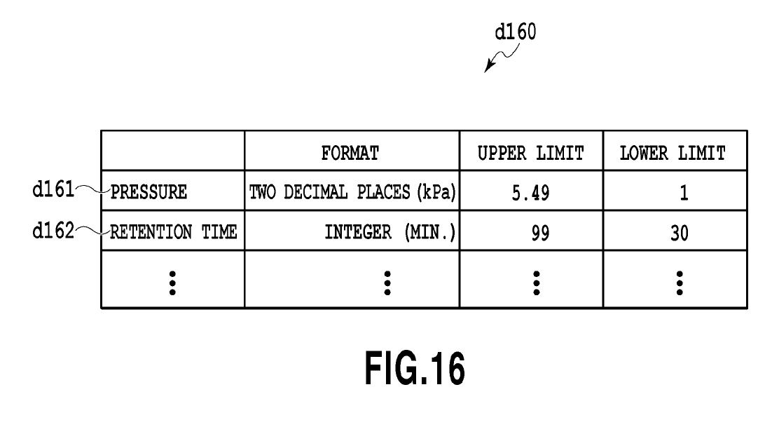

The mobile terminal 105 compares the inspection pass/fail determination data to the inspection result data, and makes a pass/fail determination for each item (step 906). For example, the mobile terminal 105 makes a determination using gas pressure threshold data which is a type of inspection pass/fail determination data, and when the gas pressure falls below the threshold, the required gas pressure is determined to be insufficient, resulting in a fail. FIG. 16 illustrates an example of inspection pass/fail determination data according to an embodiment of the present invention. The inspection pass/fail determination data d160 illustrated in FIG. 16 includes “pressure” data d161 and “retention time” data d162. The “pressure” data d161 includes a format of two decimal places (kPa), for example, and includes data with an upper limit of 5.49 (kPa) and a lower limit of 1 (kPa). The “retention time” data d162 includes a format of an integer (min), for example, and includes data with an upper limit of 99 (min) and a lower limit of 30 (min). By comparing each of the inspection result data related to leakage illustrated in FIG. 12 and FIG. 13 to the inspection pass/fail determination data, a fail may be determined if even one reference is not satisfied.

In the case of a fail as a result of the pass/fail determination conducted by the mobile terminal 105, the mobile terminal 105 transmits the result to the safety management server. The safety management server 101 receives the transmission, and on the basis of each item that failed, extracts failure safety work data from the inspection pass/fail data storage unit 327 (step 908). Failure safety work data corresponds to instruction data giving instructions for gas cylinder replacement, meter replacement, or the like when the pressure is determined to be insufficient by the safety management server 101 and results in a fail, for example.

In the case of a pass as a result of the pass/fail determination conducted by the mobile terminal 105, the mobile terminal 105 transmits a pass message to the supervising safety management server 101 on the basis of each item that passed (step 909).

The safety management server 101 transmits a fail message and failure safety work data to the mobile terminal 105 of the supervising safety inspector (step 910). The failure safety work data is communicative data indicating a re-inspection within a time period based on law in the case of a re-inspection determination, for example, or indicating that the supervisor visit the location and make a correction in the case of a fail. The specific work details are based on the stated content of “reason for failure”.

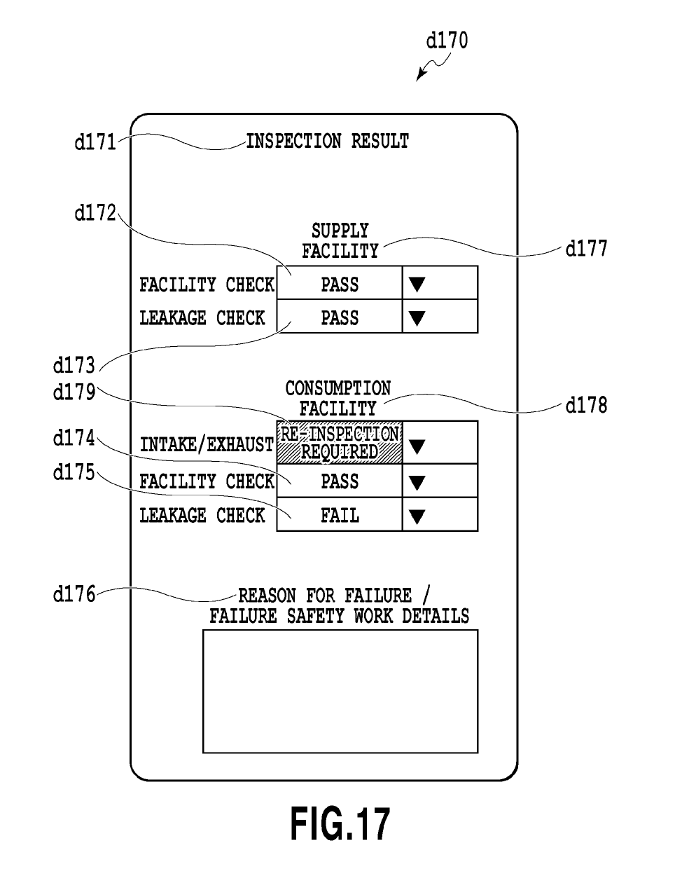

FIG. 17 illustrates an example d170 of a mobile terminal display screen expressing the pass/fail of an inspection result according to an embodiment of the present invention, and illustrates the result of a safety inspection according to the LP law. The result d171 of the safety inspection includes “pass messages” d172 to d174, a “fail message” d175, and “failure safety work data” d176. The result of the safety inspection of the “supply facility” d177 is illustrated in the top part, the result of the safety inspection of the “consumption facility” d178 is illustrated in the middle part, and the reason for failure/failure safety work details d176 is illustrated in the bottom part. In the case of the “consumption facility” d178, “re-inspection required” d179 may also be given as a result of the safety inspection. On the basis of the “re-inspection required” d179 message, the safety inspector may also conduct a re-inspection within a designated time period from the inspection date as stipulated by various laws.

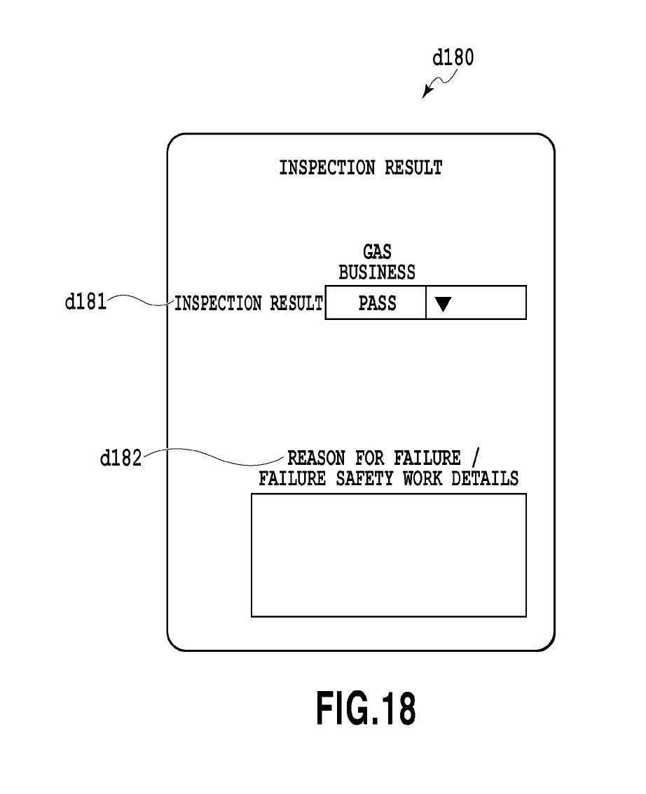

FIG. 18 illustrates an example d170 of a mobile terminal display screen expressing the pass/fail of an inspection result according to an embodiment of the present invention, and illustrates the result of a safety inspection of the consumption facility 106 according to the GB law. On the display screen d180 of the mobile terminal, a safety inspection result d181 and a reason for failure/failure safety work details d182 are indicated.

In this way, the safety management server 101 is able to transmit results of a safety inspection that differ for each law to the mobile terminal 105 of the supervising safety inspector (step 910). As a result, the supervising safety inspector may be notified.

1. A system for supporting safety work for gas facilities, the system comprising a mobile terminal and a server,
the server
receives code data sent from the mobile terminal, and
transmits an inspection slip data including inspection items selected based on the received code data and the determination data for making a pass/fail determination on the inspection items to the mobile terminal, and
the mobile terminal
based on the received determination data, makes a pass/fail determination of an inspection result input for the inspection item in the received inspection slip data,
transmits a result of the pass/fail determination of the inspection result to the server,
if the received result of the pass/fail determination is a failure, the server transmit a failure safety work data extracted from a storage device of the server based on the inspection item determined as the failure to the mobile terminal.

2. A method by a system for supporting safety work for gas facilities, the system comprising a mobile terminal and a server, the method comprising:
receiving, by a server, code data transmitted from the mobile terminal;
transmitting, by the server, an inspection slip data including inspection items selected based on the received code data and the determination data for making a pass/fail determination on the inspection items to the mobile terminal; and
based on the received determination data, making, by the mobile terminal, a pass/fail determination of an inspection result input for the safety inspection item in the received inspection slip data,
transmitting, by the mobile terminal, a result of the pass/fail determination of the inspection result to the server,
if the received result of the pass/fail determination is a failure, transmitting, by the server, a failure safety work data extracted from a storage device of the server based on the inspection item determined as the failure to the mobile terminal.

3. A computer-readable storage medium storing a program for causing a computer to execute the method according to claim 2.
